(19) United States
(12) Patent Application Publication
(10) Pub. No.: US 2009/0011064 A1
(43) Pub. Date: Jan. 8, 2009

(54) Injection Molding Machine

(75) Inventor: Hiroshi Satou, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd.

(21) Appl. No.: 11/887,919

(22) PCT Filed: Apr. 24, 2006
(86) PCT No.: PCT/JP2006/308578

§ 371 Date: Oct. 5, 2007

(30) Foreign Application Priority Data
Apr. 28, 2005 (JP) 2005-133471

(51) Int. Cl. B29C 47/92

(52) U.S. Cl. 425/150

(57) ABSTRACT

A good mold opening-and-closing accuracy is maintained by causing a stationary platen (54) in a perpendicular state in a state where a nozzle touch pressure is applied to the stationary platen (54). The stationary platen (54) is inclined toward an injection apparatus (20) side in a state where the nozzle touch pressure is not applied. A drive mechanism (40) drives the injection apparatus (20) to generate the nozzle touch pressure. Information representing a relationship between the nozzle touch pressure and an inclination amount of the stationary platen (54) is stored in a memory part (71). A control part (70) controls the nozzle touch pressure generated by the drive mechanism (40) so that the inclination amount of the stationary platen (54) is within a predetermined range.

### TECHNICAL FIELD

The present invention relates to injection molding machines and, more particularly, to an injection molding machine that injects resin while pressing a nozzle of a heating cylinder of an injection apparatus onto a mold attached to a mold-clamping apparatus.

### BACKGROUND ART

Generally, in an injection molding machine in which a mold-clamping apparatus and an injection apparatus are provided on a frame, a heating cylinder of the injection apparatus is arranged to be movable with respect to the mold-clamping apparatus. When injecting resin melted in the heating cylinder into a mold attached to the mold-clamping apparatus, the melted resin is injected into the mold while applying a pressing force (nozzle touch pressure) onto a nozzle by causing the nozzle of the heating cylinder to contact with a stationary mold attached to a stationary platen of the mold-clamping apparatus.

The stationary platen of the mold-clamping apparatus is usually fixed to the frame of the injection molding machine by cantilever supporting. That is, a bottom part of the stationary platen is fixed to the frame and an upper part of the stationary platen is free. On the other hand, the heating cylinder of the injection apparatus is configured to be horizontally movable on the frame, and the above-mentioned nozzle touch is carried out and the nozzle touch pressure is applied by moving the heating cylinder to the mold-clamping apparatus (stationary platen) side.

As a technique to detect the nozzle touch pressure, there is suggested a technique in which an elastic member such as a spring or the like is arranged between a drive part such as a heating cylinder and a frame of an injection machine, an amount of strain of the elastic member is detected by applying a pressing force onto the heating cylinder via the elastic member, and the detected amount of strain is converted into a nozzle touch pressure (for example, refer to Patent Document 1).

Patent Document: Japanese Laid-Open Patent Application No. 2000-71286

### DISCLOSURE OF THE INVENTION

### Problems to be Solved by the Invention

Usually, the stationary mold is fixed to a central part of the stationary platen, and the nozzle of the heating cylinder is pressed against a resin injection opening part provided in a central part of the stationary mold. Accordingly, a nozzle touch pressure acting on the stationary mold is received by the stationary platen. Since the stationary platen is fixed to the frame at a bottom part thereof as mentioned above, if the nozzle touch pressure acts on the central part of the stationary platen, the stationary platen slightly inclines about the fixed bottom part.

The stationary platen is mounted to the frame by being adjusted to be precisely perpendicular to the frame in a state where an external force does not act. This is for maintaining the opening-and-closing accuracy of the mold by attaching the stationary mold to a perpendicular surface of the stationary platen. However, if the inclination occurs in the stationary platen by the nozzle touch pressure as mentioned above, an inclination occurs also in the stationary mold.

Usually, since opening-and-closing of the mold is performed in a state (a nozzle touch state) where the heating cylinder is pressed against the stationary mold, the opening-and-closing of the mold is performed in the state where the inclination occurs in the stationary mold, which results in a problem in that a mold opening-and-closing accuracy is deteriorated.

The present invention was made in view of the above-mentioned problem, and it is an object of the present invention to provide an injection molding machine that can cause a stationary platen to be in a perpendicular state in a state where a nozzle touch pressure is applied to a stationary platen so that a good mold opening-and-closing accuracy can be maintained.

### Means to Solve the Problems

In order to achieve the above-mentioned objects, there is provided according to the present invention an injection molding machine comprising: a stationary platen inclined toward an injection apparatus side in a state where a nozzle touch pressure is not applied; a drive mechanism that drives the injection apparatus to generate the nozzle touch pressure; a control part that controls the nozzle touch pressure generated by the drive mechanism based on information representing a relationship between the nozzle touch pressure and an inclination amount of the stationary platen so that the inclination amount of the stationary platen is within a predetermined range.

In the above-mentioned injection molding machine according to the present invention, it is preferable that the information representing the relationship is previously stored in a memory part before molding. Additionally, the information representing the relationship may be information obtained by actually measuring the inclination amount of the stationary platen while applying the nozzle touch pressure. Alternatively, the information representing the relationship may be information obtained in a state where a stationary mold is attached to the stationary platen. Additionally, the information representing the relationship may be information obtained by assuming the inclination amount of the stationary platen by applying the nozzle touch pressure by simulation. The simulation may be performed based on a condition where a weight of a stationary mold attached to the stationary platen is considered.

Additionally, in the injection molding machine according to the present invention, the information representing the relationship may be acquired while actually measuring the inclination amount of the stationary platen during molding and may be stored in a memory part.

Further, in the injection molding machine according to the present invention, a toggle support connected to the stationary platen via tie bars and a movable platen movable along the tie bars may also be inclined as well as the stationary platen.

### EFFECTS OF THE INVENTION

In the injection molding machine according to the present invention, the stationary platen is caused previously to be in an inclined state on the injection apparatus side in a state where a nozzle touch pressure is not applied so that the stationary platen is perpendicular when a nozzle touch pressure is applied. Since mold closing is performed in a state where the nozzle touch pressure is applied during a molding operation, the mold-closing is performed in a state where the stationary platen is perpendicular, that is, in a state where the opening-and-closing surface of the stationary mold is perpendicular. Thereby, the mold closing can be performed without deterioration of accuracy of mold opening-and-closing, and a reliable molding operation can be performed surely.

### BRIEF DESCRIPTION OF THE DRAWINGS

FIG. 1 is a side view showing an entire structure of an electric injection molding machine as an example of an injection molding machine to which the present invention is applied.

FIG. 2 is a simplified side view showing a stationary platen, a heating cylinder and a plasticizer moving apparatus.

FIG. 3 is a simplified side view showing a stationary platen, a heating cylinder and a plasticizer moving apparatus.

FIG. 4 is a graph showing changes in an amount of inclination of the stationary platen when a nozzle touch pressure is varied.

FIG. 5 is a simplified side view showing a means for measuring an inclination amount of the stationary platen.

### EXPLANATION OF THE REFERENCE SIGNS

10 frame
20 injection apparatus
21 heating cylinder
40 plasticizer moving apparatus
42 plasticizer moving motor
50 mold-clamping apparatus
51 movable mold
52 movable platen
53 stationary mold
54 stationary platen
55 tie bar
56 toggle support
57 toggle mechanism
70 control part
71 memory part

### DETAILED DESCRIPTION OF THE PREFERRED EMBODIMENT

A description will be given of an injection molding machined according to an embodiment of the present invention.

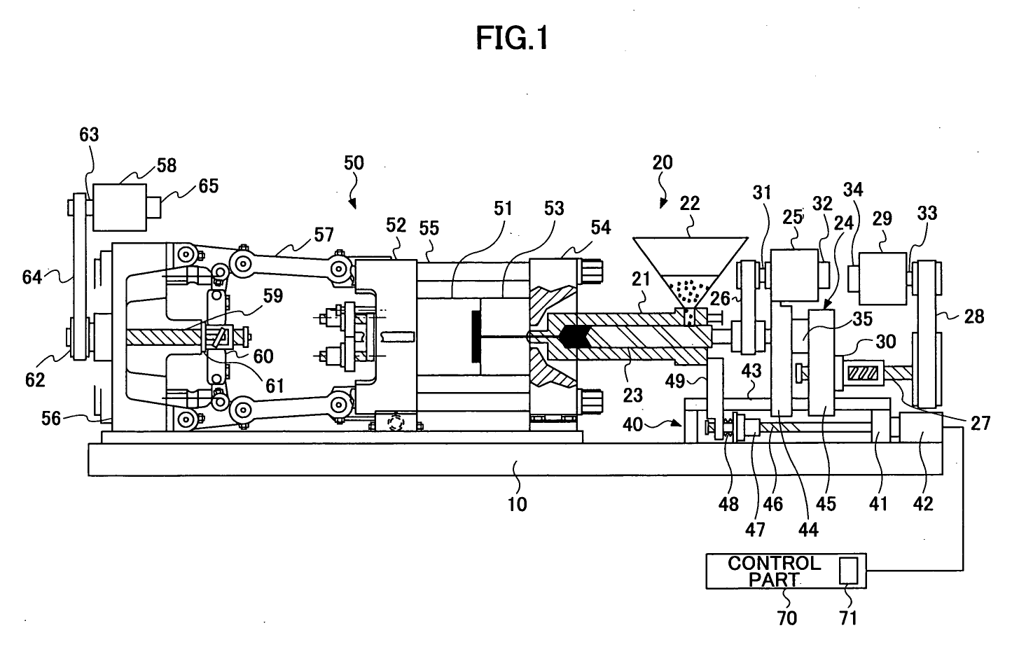

FIG. 1 is a side view showing an entire structure of an electric injection molding machine as an example of an injection molding machine to which the present invention is applied.

The electric injection molding machine shown in FIG. 1 is constituted by a frame 10 and an injection apparatus 20 and a mold-clamping apparatus 50 which are arranged on the frame 10.

The injection apparatus 20 is equipped with a heating cylinder 21, and the heating cylinder 21 is provided with a hopper 22. A screw 23 is provided movably forward and rearward and rotatably in the heating cylinder 21. A rear end of the screw 23 is rotatably supported by a movable support member 24. A metering motor 25, such as a servomotor, is mounted as a drive part to the movable support member 24. The rotation of the metering motor 25 is transmitted to the screw 23 as a part to be driven via a timing belt 26 mounted to an output shaft 31. A rotation detector 32 is connected to a rear end of the output shaft 31. The rotation detector 32 detects a rotation speed of the screw 23 by detecting a number of revolutions or an amount of rotation of the metering motor 25.

The injection apparatus 20 has a screw shaft 27 parallel to the screw 23. A rear end of the screw shaft 27 is coupled to an injection motor 29 such as a servomotor through a timing belt 28 mounted to an output shaft 33 of the injection motor 29. Therefore, the screw shaft 27 can be rotated by the injection motor 29. A front end of the screw shaft 27 is engaged with a nut 30 fixed to the movable support member 24. When the injection motor 29 is driven so as to rotate the screw shaft 27 via the timing belt 28, the movable support member 24 is moved forward and rearward, and, as a result, the screw 23 which is a part to be driven can be moved forward and rearward. A position detector 34 is connected to a rear end of the output shaft 33 of the injection motor 29. The position detector 34 detects a position of the screw 23, which indicates a driven state of the screw 23, by detecting a number of revolutions or an amount of rotation of the injection motor 29.

Here, the movable support member 24 is constituted by a front-side movable support member 44 which supports a rear end of the screw 23 via a bearing not shown in the figure and a rear-side movable member 45 which fixes the nut 30. Additionally, a load cell 35 as a pressure detection device to detect a pressure of a resin applied to the screw 23 is provided between the front-side movable support member 44 and the rear-side movable support member 45.

The injection apparatus 20 is equipped with a plasticizer moving apparatus 40 as a drive mechanism to apply a nozzle touch pressure by driving the injection apparatus 20 and is movable relative to the frame 10. The plasticizer moving apparatus 40 is provided with a plasticizer frame 41, and a plasticizer moving motor 42 as a drive part for moving the plasticizer is mounted to the plasticizer frame 41. A guide 43 is arranged along a longitudinal direction of the plasticizer frame 41 so as to guide the front-side movable support member 44 and the rear-side movable support member 45.

A ball screw shaft 46 is rotatably mounted to the plasticizer frame 41, and is rotated by the plasticizer moving motor 42. A ball nut 47 is engaged with a ball screw shaft 46 so that the ball nut 47 moves in an axial direction of the ball screw shaft 46 when the ball screw shaft 46 is rotated. A fixed support member 49 is attached to a rear end of the heating cylinder 21. The fixed support member 49 is connected to the ball nut 47 via a spring 48 as an urging member.

In the above-mentioned plasticizer moving apparatus 40, by driving the plasticizer moving motor 42, the injection apparatus 20 can be moved forward at a predetermined timing so as to bring the nozzle of the heating cylinder 21 into contact with a stationary mold 53 to achieve nozzle touch.

The mold-clamping apparatus 50 has a movable platen 52 to which the movable mold 51 is attached and the stationary platen 54 to which the stationary mold 53 is attached. The stationary platen 54 is fixed to the frame 10 at a lower end part thereof. The movable platen 52 and the stationary platen 54 are connected by tie bars 55. The movable platen 52 is movable along the tie bars 55. Additionally, the mold-clamping apparatus 50 has a toggle mechanism 57 having one end coupled to the movable platen 52 and the other end coupled to a toggle support 56. A ball screw shaft 59 is rotatably supported at a central part of the toggle support 56. The toggle support is not fixed to the frame 10 so that the tie bars 55 can be elongated when a clamping force is generated.

A nut 61 formed in a crosshead 60 provided in the toggle mechanism 57 is engaged with the ball screw shaft 59. Additionally, a pulley 62 is provided to a rear end of the ball screw shaft 59, and a timing belt 64 is provided between an output shaft 63 of a mold-clamping motor 58, such as a servomotor, and the pulley 62.

In the mold-clamping apparatus 50, when the mold-clamping motor 58 which is a drive part is driven, a rotation of the mold-clamping motor 58 is transmitted to the ball screw shaft 59 through the timing belt 64. Then, the rotational movement is converted into a linear movement by the ball screw shaft 59 and the nut 61, which results in operation of the toggle mechanism 57. The movable platen 52 is moved along the tie bars 55 due to the operation of the toggle mechanism 57 so that mold-closing, mold-claming and mold-opening are carried out.

A position detector 65 is connected to a rear end of the output shaft 63 of the mold-clamping motor 58. The position detector 65 detects a position of the crosshead 60, which is movable with rotation of the ball screw shaft 59, or the movable platen 52, which is coupled to the crosshead 60 by the toggle mechanism 57, by detecting a number of revolutions or an amount of rotation of the mold-clamping motor 58.

Moreover, the injection molding machine according to the present embodiment is provided with a control part 70, which controls operation of the plasticizer moving motor 42 which is a drive source of the plasticizer moving apparatus 40. As mention later, the control part 70 controls a nozzle touch pressure by controlling operation of the plasticizer moving motor 42. The control part 70 is constituted by a microcomputer and memories such as a ROM, a RAM, etc. The control part 70 may be included in a control device which controls operations of the entire injection molding machine. Moreover, the control part 70 is provided with a memory part 71, which consists of memories such as a RAM or the like, therein or a periphery thereof so that information (data) used for controlling the nozzle touch pressure is stored as mentioned later.

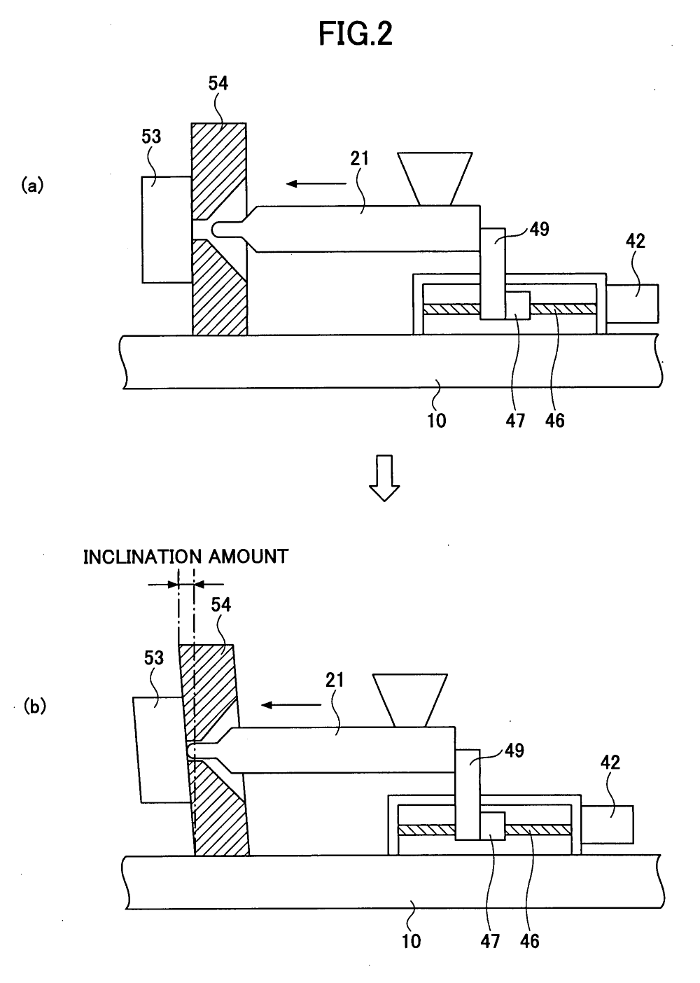

In the injection molding machine of the above-mentioned structure, conventionally as shown in FIG. 2-(a), the stationary platen 54 is mounted perpendicularly to the frame 10. For example, a perpendicularity of the stationary platen 54 to the frame 10 is measured when assembling the injection molding machine, and adjustment is made by providing shims in a part of mounting the stationary platen 54 so as to achieve perpendicularity. Therefore, the stationary platen 54 is perpendicular to the frame 10, as shown in FIG. 2-(a), at the time of the factory shipment of the injection molding machine.

However, when the injection molding machine is shipped and is actually operated at the destination of shipment, the nozzle of the heating cylinder 21 is brought into contact with the stationary mold 53 and a nozzle touch pressure is applied, and, thereby, the stationary platen 54 inclines in a direction opposite to the injection apparatus 20 as shown in FIG. 2-(b). If the stationary platen 54 inclines, the stationary mold 53 attached to the stationary platen 54 also inclines, which results in deterioration of mold opening-and closing accuracy.

In the conventional injection molding machine, it has been coped with by giving rigidity to the fixing part of the stationary platen 54 to the frame 10 so as to prevent the inclination as much as possible even when a nozzle touch pressure is applied. However, according to the cantilever support structure in which the lower end part of the stationary platen 54 is fixed to the frame 10, an inclination of the stationary platen 54 always occurs. Especially, a resin requiring a large injection pressure requires a large nozzle touch pressure causes a large inclination of the stationary platen 54, which results in deterioration of mold opening-and-closing accuracy.

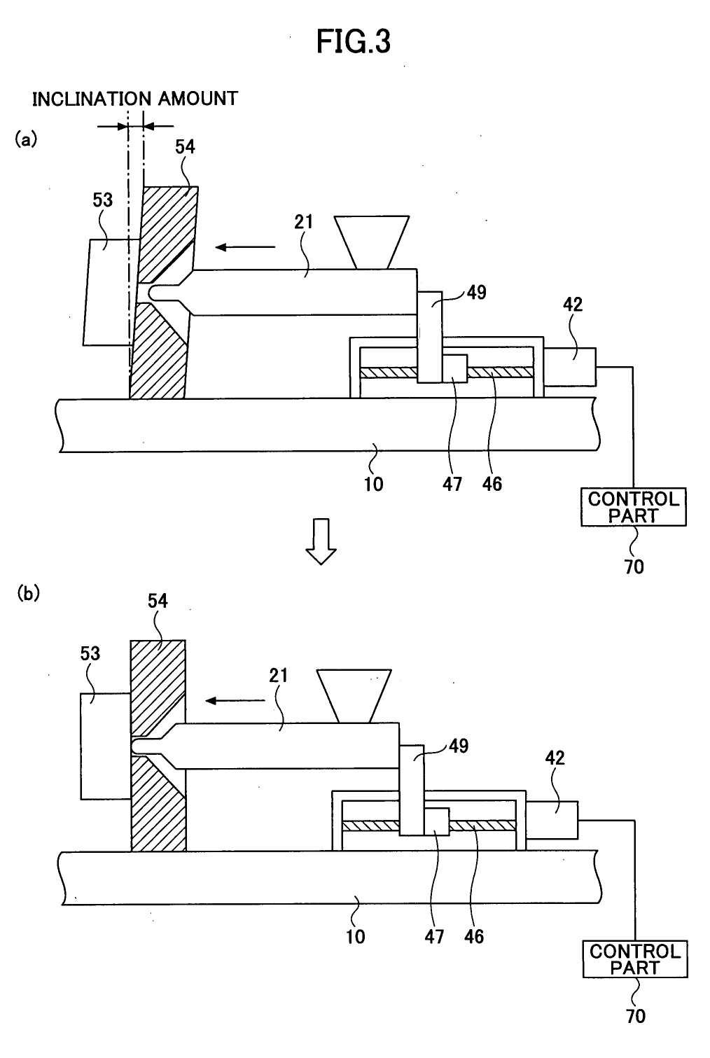

It should be noted that FIG. 2 is a simplified view of the stationary platen 54, the heating cylinder 21 and the plasticizer moving apparatus 40, and the inclination of the stationary platen 54 is indicated by being emphasized. Additionally, FIG. 3 mentioned below is also a simplified view showing the stationary platen 54, the heating cylinder 21 and the plasticizer moving apparatus 40, and the inclination of the stationary platen 54 is indicated by being emphasized.

In the present embodiment, in order to prevent deterioration of the mold opening-and-closing accuracy due to the above-mentioned inclination of the stationary platen 54, the stationary platen 54 is mounted to the frame by being caused to incline to the injection apparatus 20 side beforehand as shown in FIG. 3-(a). The stationary platen 54, which is mounted to the frame 10 by being caused to incline beforehand, inclines in a direction opposite to the injection apparatus 20 when a nozzle touch pressure is acted. That is, the previously given inclination is reduced, and the stationary platen 54 inclines in a direction in which is becomes perpendicular to the frame 10.

Thus, the stationary platen 54 is inclined beforehand toward the injection apparatus 20 side based on a relationship between the nozzle touch pressure and the inclination of the stationary platen 54 so that the previously given inclination is cancelled and the stationary platen 54 becomes perpendicular when the nozzle touch pressure is applied. FIG. 3-(b) is a view showing a state where a nozzle touch pressure is applied in a state where the stationary platen 54 is inclined beforehand as shown in FIG. 3-(a). The inclination of the stationary platen 54 is returned, and the stationary platen 54 is substantially perpendicular to the frame 10. In this case, since it is difficult to make the stationary platen 54 to be perpendicular completely, what is necessary is just to configure and arrange the stationary platen 54 so that the inclination is within a predetermined angle range close to perpendicular in which an influence to the mold opening-and-closing accuracy can be neglected.

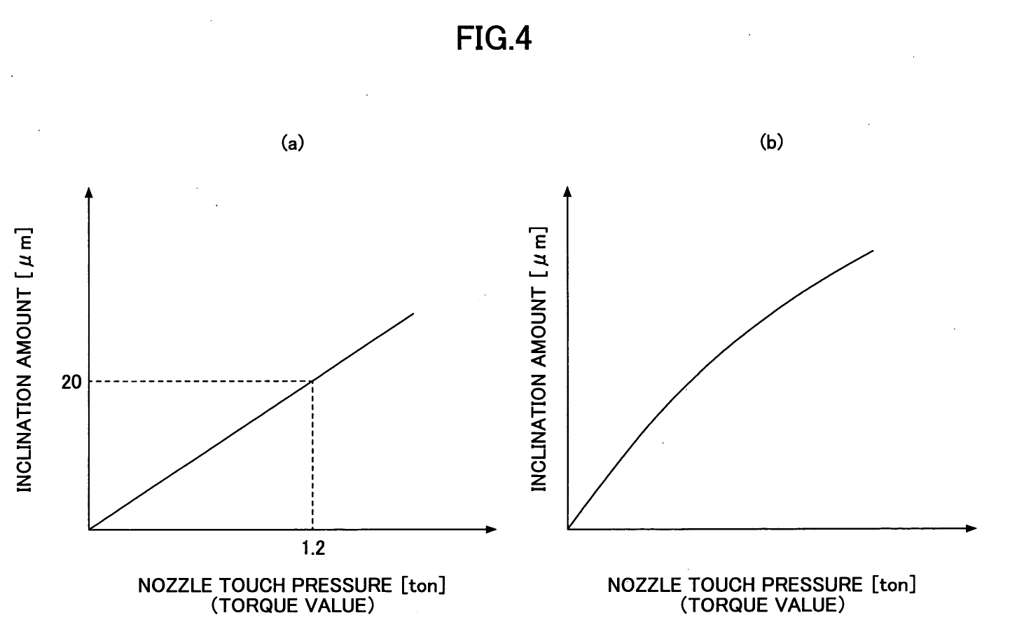

Here, a description will be given, with reference to FIG. 4, of the relationship between the inclination of the stationary platen 54 and the nozzle touch pressure. FIG. 4 is a graph showing how an amount of inclination of the stationary platen 54 changes when the nozzle touch pressure is varied, FIG. 4-(a) shows a graph where the amount of inclination can be represented by a linear approximated curve, and FIG. 4-(b) shows a graph where the amount of inclination can be represented by a three-dimensional approximated curve.

Although there are various methods to measure an amount of inclination of the stationary platen 54, the amount of inclination here is defined as a distance of horizontal movement of an upper end part which is a free end of the stationary platen 54. Additionally, the nozzle touch pressure can be measured directly by arranging a load cell between a rear end part of the heating cylinder 21 and the fixing support member 49. Or, since an output torque value of the plasticizer moving motor 42 is proportional to the nozzle touch pressure, this value may be used instead of the nozzle touch pressure.

For example, when the relationship between an amount of inclination of the stationary platen 54 and the nozzle touch pressure is expressed by the graph shown in FIG. 4-(a), it can be appreciated that the amount of inclination of the stationary platen 54 is 20 μm when 1.2t is applied as a nozzle touch pressure to the stationary mold 53. In this case, if the stationary platen 54 is mounted and fixed to the frame 10 in a state where the stationary platen 54 is inclined to the injection apparatus 20 side by 20 μm beforehand, the stationary platen 54 inclines in a direction opposite to the injection apparatus 20 by 20 μm when the nozzle touch pressure of 1.2t is applied to the stationary mold 53. Thereby, when the nozzle touch pressure of 1.2t is applied to the stationary mold 53, the previously given amount of inclination 20 μm to the injection apparatus 20 side is cancelled and the stationary platen 54 is in a perpendicular state.

Therefore, the amount of inclination is actually measured while varying the nozzle touch pressure so as to acquire the relationship between the amount of inclination and the nozzle touch pressure such as shown in FIG. 4-(a) or FIG. 4-(b). Then, by storing an equation representing the relationship between the amount of inclination and the nozzle touch pressure in the memory part 71, the control part 70 can acquire the nozzle touch pressure necessary for making the stationary platen 54 to be perpendicular by calculation. Then, the control part 70 converts the acquired, nozzle touch pressure into a torque value (when the equation expressing the amount of inclination and the torque value is stored, the torque value can be acquired directly), and controls the output of the plasticizer moving motor 42 so that the torque value is output.

Instead of storing the equation expressing the relationship between the amount of inclination and the nozzle touch pressure, values of the amount of inclination with respect to various values of the nozzle touch pressure may be stored in the memory part 71 as data such as table information or map data so as to directly acquire the nozzle touch pressure (or the torque value) from the amount of inclination. That is, information representing the relationship between the amount of inclination and the nozzle touch pressure may be stored in the memory part 71.

The equation representing the amount of inclination and the nozzle touch pressure is stored in the memory part 71 by previously acquiring it before shipping the injection molding machine. In this case, the equation representing the relationship between the amount of inclination and the nozzle touch pressure expresses the relationship between the amount of inclination and the nozzle touch pressure in a state where the stationary mold 53 is not attached to the stationary platen 54.

Thus, an amount of inclination of the stationary platen 54 may be measured actually while applying the nozzle touch pressure in a state where the stationary mold 53, which is actually used at the destination of shipment, is attached so as to store the relationship between the thus-acquired amount of inclination and the nozzle touch pressure in the memory part 71. The amount of inclination of the stationary platen 54 may be influenced by the weight of the stationary mold 53 to be attached. In such a case, a control can be made so that the nozzle touch pressure (torque value) for causing the stationary platen 54 to be perpendicular more accurately can be obtained by acquiring the relationship equation under a condition close to an actual condition at the destination of shipment, that is, by acquiring the relationship equation in consideration of the weight of the mold.

Moreover, the amount of inclination of the stationary platen 54 can be controlled based on the relationship equation closer to an actual condition by acquiring the relationship equation during actual molding while measuring the amount of inclination of the stationary platen 54 and updating the relationship equation stored in the memory part 71 by sequentially rewriting. For example, a thermal expansion may occur in the stationary platen during molding due to a rise in a mold temperature, which may gradually change the amount of inclination. In such a case, it can be coped with such a change in the amount of inclination by sequentially rewriting the relationship equation.

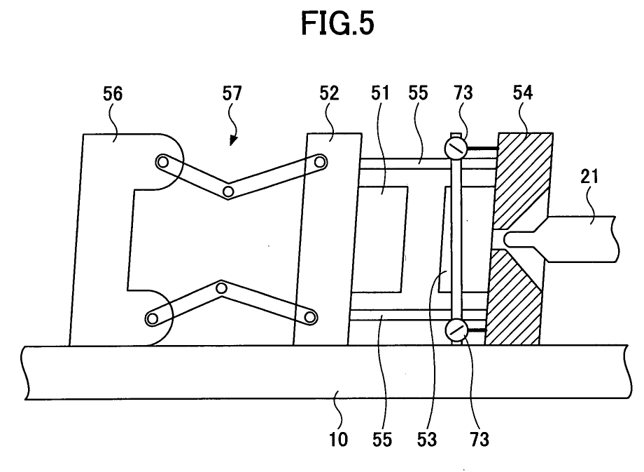

As mentioned above, the means to measure the amount of inclination of the stationary platen 54 can be achieved by measuring changes of the position of the upper end part of the stationary platen 54 by a precision distance measurement equipment such as a dial gauge 73, for example, as shown in FIG. 5. The dial gauges 73 are fixed to the frame 10 or a floor where the injection molding machine is installed and can measure a moving distance of the upper end part of the stationary platen 54 in a horizontal direction. It should be noted that, in the example shown in FIG. 5, the dial gauges 73 are provided at positions corresponding to the upper end part and the lower end part of the stationary platen 54 to measure displacement so as to acquire an amount of inclination as a difference between the displacement of the upper end part and the displacement of the lower end part. Thereby, even if the stationary platen is slightly displaced due to the nozzle touch pressure, such a displacement is reflected in the displacement of the lower end part, and, thus, the amount of inclination can be acquired accurately.

The means to measure the amount of inclinations is not limited to the dial gauge, and a known micro distance measurement technique such as a linear sensor, a gap sensor, a laser displacement meter, etc., can be used. Moreover, the above-mentioned relationship equation can be acquired based on an amount of inclination assumed by using computer simulation other than acquiring it by actually measuring the amount of inclination.

Although an inclination is provided to the stationary platen 54 beforehand in the above-mentioned embodiment, with the inclination of the stationary platen 54, the toggle support 56 connected via the tie bars 55 is also inclined and the movable platen 52 movable along the tie bars 55 is also inclined such as shown in FIG. 5. That is, in the above-mentioned embodiment, an inclination is provided intentionally to the movable platen 52 and the toggle support 56 beforehand simultaneously with the stationary platen 54.

The present invention is not limited to the specifically disclosed embodiments, and variations and modifications may be made without departing from the scope of the present invention.

The present application is based on Japanese priority application No. 2005-133471 filed Apr. 28, 2005, the entire contents of which are hereby incorporated herein by reference.

### INDUSTRIAL APPLICABILITY

The present invention is applicable to injection molding machines having a mold-clamping apparatus and an injection apparatus.

1. An injection molding machine comprising:
a stationary platen inclined toward an injection apparatus side in a state where a nozzle touch pressure is not applied;
a drive mechanism that drives the injection apparatus to generate the nozzle touch pressure;
a control part that controls the nozzle touch pressure generated by the drive mechanism based on information representing a relationship between the nozzle touch pressure and an inclination amount of the stationary platen so that the inclination amount of said stationary platen is within a predetermined range.

2. The injection molding machine as claimed in claim 1, wherein the information representing said relationship is previously stored in a memory part before molding.

3. The injection molding machine as claimed in claim 2, wherein the information representing said relationship is information obtained by actually measuring the inclination amount of said stationary platen while applying the nozzle touch pressure.

4. The injection molding machine as claimed in claim 2, wherein the information representing said relationship is information obtained in a state where a stationary mold is attached to said stationary platen.

5. The injection molding machine as claimed in claim 2, wherein the information representing said relationship is information obtained by assuming the inclination amount of said stationary platen by applying the nozzle touch pressure by simulation.

6. The injection molding machine as claimed in claim 5, wherein said simulation is performed based on a condition where a weight of a stationary mold attached to said stationary platen is considered.

7. The injection molding machine as claimed in claim 1, wherein the information representing said relationship is acquired while actually measuring the inclination amount of said stationary platen during molding and is stored in a memory part.

8. The injection molding machine as claimed in claim 1, wherein a toggle support connected to said stationary platen via tie bars and a movable platen movable along the tie bars are also inclined as well as said stationary platen.
